(19) United States
(12) Patent Application Publication
(10) Pub. No.: US 2013/0050747 A1
(43) Pub. Date: Feb. 28, 2013

(54) AUTOMATED PHOTO-PRODUCT SPECIFICATION METHOD

(71) Applicants: Ronald Steven Cok, Rochester, NY (US); Timothy G. Thompson, Delevan, NY (US)

(72) Inventors: Ronald Steven Cok, Rochester, NY (US); Timothy G. Thompson, Delevan, NY (US)

(21) Appl. No.: 13/222,799

(22) Filed: Aug. 31, 2011

(51) Int. Cl. G06K 15/02

(52) U.S. Cl. 358/1.15

(57) ABSTRACT

An apparatus for making an image product with an electronic memory for storing digital images and type data for indicating an image type for each associated digital image. A processor coupled to the electronic memory electronically selects digital images using the stored type data for forming an image distribution matching a first predefined distribution of image types. The distribution can be selected by a user, automatically by a programmed processor of the apparatus, or it can be prestored in the apparatus, on a network device, or on a portable storage device.

### CROSS REFERENCE TO RELATED APPLICATIONS

Reference is made to commonly-assigned, U.S. patent application Ser. No. ______ (Docket K000416), entitled “Automated Photo-Product Specification Method”, Ser. No. ______ (Docket K000564), entitled “Automated Photo-Product Specification Method”, Ser. No. ______ (Docket K000565), entitled “Automated Photo-Product Specification Method”, all filed concurrently herewith.

### FIELD OF THE INVENTION

The present invention relates to photographic products that include multiple images and more specifically to automated methods for selecting images to be included in a photographic product.

### BACKGROUND

Products that include images are a popular keepsake or gift for many people. Such products typically include an image captured by a digital camera that is inserted into the product and is intended to enhance the product, the presentation of the image, or to provide storage for the image. Examples of such products include picture albums, photo-collages, posters, picture calendars, picture mugs, t-shirts and other textile products, picture ornaments, picture mouse pads, and picture post cards. Products such as picture albums, photo-collages, and picture calendars include multiple images. Products that include multiple images are designated as photographic products, image products, or photo-products, herein.

When designing or specifying photographic products, it can be desirable to select a variety of images that provide interest and aesthetic appeal. For example, a selection of images having different subjects, taken at different times under different conditions can provide interest. In contrast, in a consumer product a selection of similar images of the same subject taken under similar conditions is unlikely to be as interesting.

In conventional practice, images for a photographic product are selected by a product designer or customer, either manually or with the help of tools. For example, graphic and imaging software tools are available to assist a user in laying out a multi-image product, such as a photo-book. Similarly, on-line tools available over the internet from a remote computer server enable users to specify photographic products. The Kodak Gallery provides such image product tools. However, in many cases consumers have a large number of images, for example stored in an album in a computer-controlled electronic storage device using imaging software desktop or on-line tools. The selection of an appropriate variety of images from the large number of images available can be tedious and time consuming.

Imaging tools for automating the specification of photographic products are known in the prior art. For example, tools for automating the layout and ordering of images in a photo-book are available from the Kodak Gallery as are methods for automatically organizing images in a collection into groups of images representative of an event. It is also known to divide groups of images representative of an event into smaller groups representative of sub-events within the context of a larger event. For example, images can be segmented into event groups or sub-event groups based on the times at which the images in a collection were taken. U.S. Pat. No. 7,366,994, incorporated by reference herein in its entirety, describes organizing digital objects according to a histogram timeline in which digital images can be grouped by time of image capture. U.S. Patent Publication No. 2007/0008321, incorporated by reference herein in its entirety, describes identifying images of special events based on time of image capture.

Semantic analyses of digital images are also known in the art. For example, U.S. Pat. No. 7,035,467, incorporated by reference herein in its entirety, describes a method for determining the general semantic theme of a group of images using a confidence measure derived from feature extraction. Scene content similarity between digital images can also be used to indicate digital image membership in a group of digital images representative of an event. For example, images having similar color histograms can belong to the same event.

U.S. Patent Publication No. 2008/0304808, incorporated by reference herein in its entirety, describes a method and system for automatically creating an image product based on media assets stored in a database. A number of stored digital media files are analyzed to determine their semantic relationship to an event and are classified according to requirements and semantic rules for generating an image product. Rule sets are applied to assets for finding one or more assets that can be included in a story product. The assets, which best meet the requirements and rules of the image product are included.

U.S. Pat. No. 7,836,093, incorporated by reference herein in its entirety, describes systems and methods for generating user profiles based at least upon an analysis of image content from digital image records. The image content analysis is performed to identify trends that are used to identify user subject interests. The user subject interests may be incorporated into a user profile that is stored in a processor-accessible memory system.

U.S. Patent Publication No. 2009/0297045, incorporated by reference herein in its entirety, teaches a method of evaluating a user subject interest based at least upon an analysis of a user's collection of digital image records and is implemented at least in part by a data processing system. The method receives a defined user subject interest, receives a set of content requirements associated with the defined user-subject-interest, and identifies a set of digital image records from the collection of digital image records each having image characteristics in accord with the content requirements. A subject-interest trait associated with the defined user-subject-interest is evaluated based at least upon an analysis of the set of digital image records or characteristics thereof. The subject-interest trait is associated with the defined user-subject-interest in a processor-accessible memory.

U.S. Patent Publication No. 2007/0177805, incorporated by reference herein in its entirety, describes a method of searching through a collection of images, includes providing a list of individuals of interest and features associated with such individuals; detecting people in the image collection; determining the likelihood for each listed individual of appearing in each image collection in response to the people detected and the features associated with the listed individuals; and selecting in response to the determined likelihoods a number of images such that each individual from the list appears in the selected images. This enables a user to locate images of particular people.

U.S. Pat. No. 6,389,181, incorporated by reference herein in its entirety, discusses photo-collage generation and modification using image processing by obtaining a digital record for each of a plurality of images, assigning each of the digital records a unique identifier and storing the digital records in a database. The digital records are automatically sorted using at least one date type to categorize each of the digital records according at least one predetermined criteria. The sorted digital records are used to compose a photo-collage. The method and system employ data types selected from digital image pixel data; metadata; product order information; processing goal information; or a customer profile to automatically sort data, typically by culling or grouping, to categorize images according to either an event, a person, or chronology.

U.S. Pat. No. 6,671,405, incorporated by reference herein in its entirety, to Savakis, et al., entitled “Method for automatic assessment of emphasis and appeal in consumer images,” discloses an approach which computes a metric of “emphasis and appeal” of an image, without user intervention and is included herein in its entirety by reference. A first metric is based upon a number of factors, which can include: image semantic content (e.g. people, faces); objective features (e.g., colorfulness and sharpness); and main subject features (e.g., size of the main subject). A second metric compares the factors relative to other images in a collection. The factors are integrated using a trained reasoning engine. The method described in U.S. Patent Publication No. 2004/0075743 by Chantani et al., entitled “System and method for digital image selection”, incorporated by reference herein in its entirety, is somewhat similar and discloses the sorting of images based upon user-selected parameters of semantic content or objective features in the images. U.S. Pat. No. 6,816,847 to Toyama, entitled “Computerized aesthetic judgment of images”, incorporated by reference herein in its entirety, discloses an approach to compute the aesthetic quality of images through the use of a trained and automated classifier based on features of the image. Recommendations to improve the aesthetic score based on the same features selected by the classifier can be generated with this method. U.S. Patent Publication No. 2011/0075917, incorporated by reference herein in its entirety, describes estimating aesthetic quality of digital images and is incorporated herein in its entirety by reference. These approaches have the advantage of working from the images themselves, but are computationally intensive.

While these methods are useful for sorting images into event groups, temporally organizing the images, assessing emphasis, appeal, or image quality, or recognizing individuals in an image, they do not address the need for automating the selection of images from a large collection of images to provide a selection of a variety of images that provide interest and aesthetic appeal.

There is a need therefore, for an improved automated method for selecting images from a large collection of images to provide a selection of a variety of images that provide interest and aesthetic appeal in a photographic product.

### SUMMARY OF THE INVENTION

Preferred embodiments of the present invention have the advantage of automating the production of photo-products and enhancing the quality of the photo-product through an improved selection of a variety of images that provide interest and aesthetic appeal. In particular, multiple different photo-products are provided having different images selected from the same image collection.

A preferred embodiment of the present invention includes an apparatus for making an image product with an electronic memory for storing digital images and type data for indicating an image type for each associated digital image. The digital images include different image types. A processor coupled to the electronic memory electronically selects digital images using the stored type data for forming an image distribution matching a first predefined distribution of image types. The distribution can be selected by a user, automatically by a programmed processor of the apparatus, or it can be prestored in the apparatus, on a network device, or on a portable storage device created therein by either of the methods just described. Means for incorporating digital images into an image product is included in the apparatus for digital display. These means are configured to incorporate the same group of digital images into another image product for digital display. Altogether, the same or different distributions of digital images can be incorporated by the apparatus into different image products for digital display. Prints of digital images can be incorporated into image products at a service provider implementing the apparatus of the present invention. A relative frequency of image types associated with a collection of digital images can be calculated and a group of digital images from the collection can be selected to have an equivalent distribution. The different image types include two or more of the following: portrait orientation, landscape orientation, scenic image, image that includes a person, close-up image of a person, group image that includes multiple people, scenic image that includes a person, day-time image, night-time image, image including one or more animals, black-and-white image, color image, identified person, identified gender, flash-exposed image, similarity, and aesthetic value. Predefined distributions can be distinguished on the basis, for example, of identified persons which itself is a type of digital image classification. A predefined distribution can also include classifications of close-up, individual, or group images including an identified person. Different distributions can be selected from a same collection of digital images to start with. The same distribution can be selected from a collection of digital images with each distribution having unique individual images. Duplicate or dud digital images can be deleted from a collection of digital images before a predefined distribution selection begins. Ranking a quality or similarity of digital images for preferentially selecting certain digital images can also be programmed. A user interface is used for receiving user selections for defining a predefined distribution of image types, which definition can be based on number of each type or relative percentages of the image types.

Another preferred embodiment of the present invention includes a system for making an image product comprising a processor, a digital image storage device connected to the processor, means for receiving a plurality of digital images, with each of the digital images having type data associated therewith for indicating a type of the digital images. The digital images include digital images of at least two different types. The digital images and the type data are stored in the digital image storage device. A variety of the digital images can be grouped to satisfy a specified distribution. An offering photo-products for inclusion of the selected variety of the digital images is part of the system.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale with respect to relative size, angular relationship, or relative position nor to any combinational relationship with respect to interchangeability, substitution, or representation of an actual implementation.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 illustrates a flow diagram according to a preferred embodiment of the present invention;

FIG. 2 illustrates a flow diagram according to another preferred embodiment of the present invention;

FIG. 3 illustrates a histogram of image types useful in understanding the present invention;

FIG. 4 illustrates a 100% stacked column chart of an image type distribution useful in understanding the present invention;

FIG. 5 illustrates another 100% stacked column chart of an image type distribution useful in understanding the present invention;

FIG. 6 illustrates a distribution of image types useful in understanding the present invention;

FIGS. 7A and B illustrate 100% stacked column charts of two different distributions of identified persons useful in understanding the present invention;

FIG. 8 is a simplified schematic of a computer system useful for the present invention;

FIG. 9 is a schematic of a computer system useful for preferred embodiments of the present invention;

FIG. 10 is a schematic of another computer system useful for preferred embodiments of the present invention;

FIG. 11 illustrates a flow diagram according to another preferred embodiment of the present invention; and

FIG. 12 illustrates a flow diagram according to another preferred embodiment of the present invention.

### DETAILED DESCRIPTION OF THE INVENTION

According to the present invention, an image product, photographic product, or photo-product is a printed or electronic product that includes multiple images incorporated into an image-related object, such as for example a photo-book, photo-album, a photo-card, a picture greeting card, a photo-collage, a picture mug, or other image-bearing product. The images can be a user's personal images and the image product can be personalized. The images can be located in specified pre-determined locations or can be adaptively located according to the sizes, aspect ratios, orientations and other attributes of the images. Likewise, the image sizes, orientations, or aspect ratios included in the image product can be adjusted, either to accommodate pre-defined templates with specific pre-determined openings or adaptively adjusted for inclusion in an image-bearing product.

As intended herein, an image product can include printed images, for example images printed on photographic paper, cardboard, writing paper, textiles, ceramics, rubber such as foam rubber, and polymers. These printed images can be assembled or bound into image products. In an alternative embodiment, the image product can be an electronic image product suitable for display on an electronic display by a computing device and stored as a file, or multiple files, in an electronic storage system such as a computer-controlled disk drive or solid-state memory. Such image products can include, for example, photobooks, collages, or slide shows that include one or more images with or without ancillary images such as templates, backgrounds, clip art and the like. In various embodiments, an image product includes a single still image, multiple still images, or video images and can include other sensory modalities such as sound. The electronic image products are displayed by a computer on a display, for example as a single image or by sequentially displaying multiple pages in the image product together with outputting any other related image product information such as sound. Such display can be interactively controlled by a user. Such display devices and image products are known in the art as are user interfaces for controlling the viewing of image products on a display.

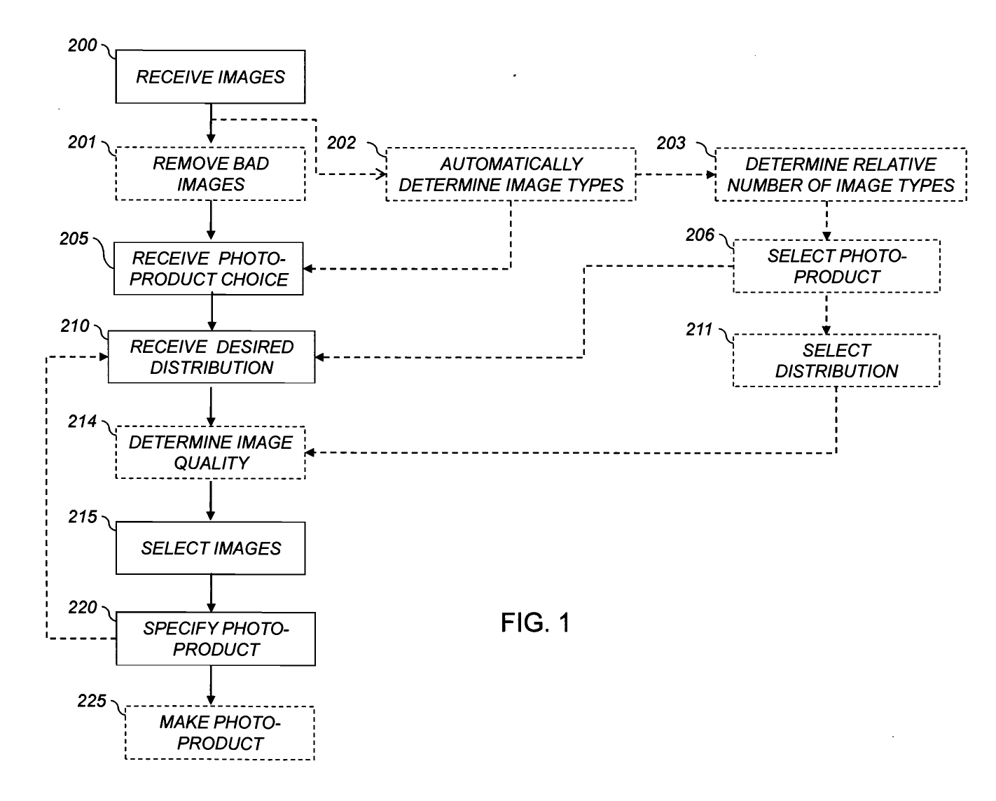

Referring to FIG. 1, in a preferred embodiment, the present invention is addressed to a method of making a photo-product comprising using a programmed processor to receive a plurality of digital images in step 200, wherein each digital image has an image type and the plurality of digital images includes digital images of at least two different image types, selecting a variety of the digital images to provide a desired distribution of the digital image types in the selection in step 215, and specifying a photo-product that includes the selected variety of digital images in step 220. A specified photo-product is one for which the number and types of digital images have been selected by a user or other process, such as a programmed automated process. Image products can also be distinguished by type, for example, photo-books, photo-cards, picture greeting cards, and photo-collages are of different image-product types. Each of these can be generated in electronic form, which can be electronically transmitted over communication networks, or as an image-product object which can be physically delivered by known means and methods of mechanical and manual transport. All electronic image products viewable only on an electronic display are considered herein as of a different type from all hardcopy or image-product objects.

According to a preferred embodiment of the present invention, the digital images in a plurality of digital images each have an image type. An image type is a category or classification of image attributes and can be associated with a digital image as image metadata stored with the digital image in a common electronic file or associated with the digital image in a separate electronic file. An image can have more than one image type. For example, a digital image can have an image type such as a portrait orientation type, a landscape orientation type, or a scenic image type. The same digital image can also be classified as an image that includes a person type, a close-up image of a person type, a group image that includes multiple people type, day-time image type, night-time image type, image including one or more animals type, black-and-white image type, color image type, identified person type, identified gender type, and flash-exposed image type. An image type can be an image-usage type classifying the digital image as a popular image and frequently used. Other types can be defined and used as needed for particular image products or as required for desired image distributions. Therefore, a variety of digital images having a desired distribution of image types such as those listed above can be selected.

An image type can include a value that indicates the strength or amount of a particular type for a specific image. For example, an image can be a group image, but if it only includes two people, the strength of the group-type is relatively weak compared to a group image that includes 10 people. In this example, an integer value representing a number of persons appearing in the digital image can be stored with or in association with the digital image to indicate its group-type strength or value. As an example of ranking group-type digital images, a collection of these images can be sorted in descending order according to a magnitude of their group-type value. A selection algorithm for finding images depicting a group can be programmed to preferably select images with a higher group-type value by preferably selecting images from the top of the sorted list.

An image-usage type can have a strength value indicating how often or how much the corresponding digital image is used, for example including a combination of metrics such as how often the image is shared or viewed, whether the image was purchased, edited, used in products, or whether it was deleted from a collection. Alternatively, each of those attributes could be a separate image type classification. The image-usage type(s) can indicate how much a user values the corresponding digital image. As an example ranking method, the number of times that an image file was opened, or an image shared or viewed can be accumulated for each image and then the images ranked in descending order according to the number. A preferential selection scheme can then be implemented whereby the images listed at the top of the ranking are preferentially selected.

An image type can also include a similarity metric that indicates the relative uniqueness of the image. For example, if an image is very different from all of the other images, it can have a high uniqueness image-type value (or an equivalent low similarity value). If an image is similar to one or more of the other images, it can have a low uniqueness image-type value (or an equivalent high similarity value) depending on the degree of similarity and the number of images to which it is similar. Thus, every image can have the same image type but with varying values. The image-type value can also be associated with a digital image as image metadata stored with the digital image in a common electronic file or associated with the digital image in a separate electronic file.

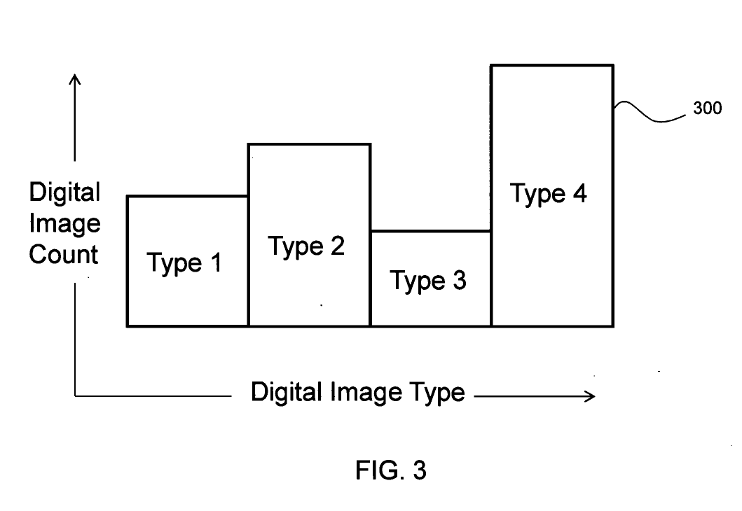

Referring to FIG. 3, a histogram of a digital image collection having a plurality of digital images of four different image types is illustrated. This kind of histogram profile is also referred to herein as an image distribution. An image distribution can be used to describe a collection of digital images in a database (collection) of images or in an image-product, and it can be used as a filter or template to predefine a distribution of digital images, which is then used to select images from an image collection (or database) to be included in an image product. The height of each column indicates the count 300 of digital images in the collection of the digital image of the type marked. In this example, the largest plurality of the digital images are of image type four, followed by digital images of image type 2 and then digital images of image type 1. The fewest digital images are of image type 3. As another example, a digital image collection containing one hundred different digital images classified into four image types of twenty-five digital images each has an image distribution that is equivalent to a collection of four images with one each of the four exclusive image types, because both distributions contain 25% each of four image types. Thus, the one hundred image collection can generate twenty-five unique groups of images having the same image distribution as the original collection without any image repeated in any of the groups. Hence, the term “equivalent image distribution” can describe two or more collections of images that: each contain an identical copy of a set of images; each contain the same number of images of each image type (whether or not any digital image is duplicated within a collection or between collections); or each contain the same percentage of digital images for each image type.

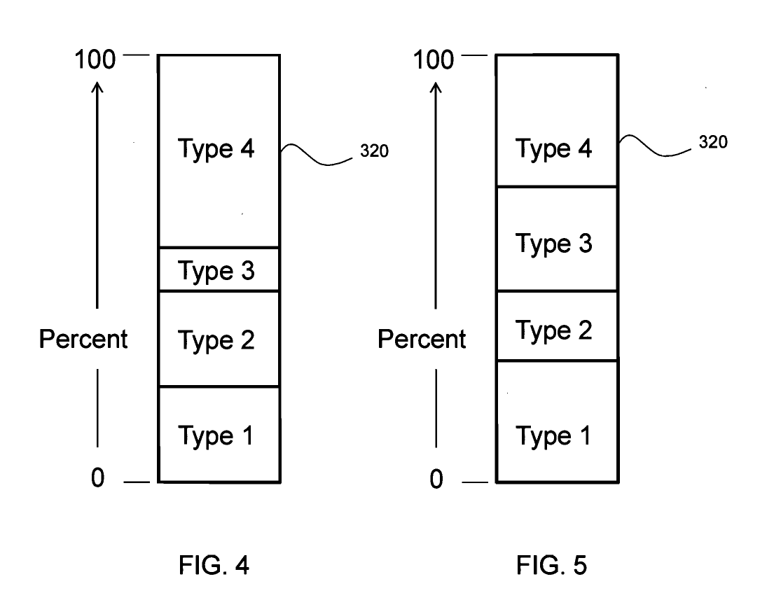

Further, according to a preferred embodiment of the present invention, a desired, or predefined, distribution of digital image types is a specification of the relative frequency of digital images of each type to be included in an image product. In such an image distribution, a percentage is used rather than a direct image count (see FIGS. 4-6). A predefined distribution and a desired distribution can often be used interchangeably herein. A predefined (desired) distribution is merely a user defined or an automated computer defined distribution that is stored as a template or filter to be used for image selection prior to executing a programmed (electronic) selection procedure upon a digital-image collection. Such predefined distributions can be stored for future use. For example, a first desired distribution specification can include 20% scenic images, 60% scenic images that include a person, and 20% close-up images. The actual number of images of each type is then calculated by multiplying the total number of images in the desired photo-product by the percentage associated with the image type in the desired distribution. The total number of digital images in the photo-product is determined by the photo-product to be used. A desired distribution can also include multiple values corresponding to an image type that has multiple values rather than a simple binary classification value.

Referring to FIGS. 4 and 5, two different desired distributions of image types are illustrated in a 100% stacked column chart in which the total number of image types is 100%. In FIG. 4, the percent image-type desired distribution 320 of image type 4 is largest, similar to the desired distribution of image types in the collection. However, the prevalence of image type 3 in the desired distribution is relatively smaller than in the collection and the prevalence of image types 1 and 2 in the desired distribution are equal. Thus, according to the example of FIG. 4, the desired distribution of image types in a photo-product has relatively fewer digital images of image type 2 and 3 than are in the original collection.

Referring to the second example of FIG. 5, the percent image-type desired distribution 320 of image types 2 and 4 are relatively reduced while the percent image-type desired distribution of image types 3 and 1 are increased.

Because a digital image can have multiple image types, a desired distribution need not have a relative frequency of digital images that adds to 100%. For example an image can be a landscape image, a scenic image, and a scenic image that includes a person. Similarly, a close-up image can be a portrait image and a flash image. Thus, in a second example, a second desired distribution can include 10% scenic images, 40% landscape orientation, 80% day-time image, 100% color image, 60% scenic image that includes a person, and 20% close-up image. In an alternative embodiment, the image types can be selectively programmed to be mutually exclusive so that no image is determined to have more than one image type. In this instance the relative distribution percentages should add up to 100%.

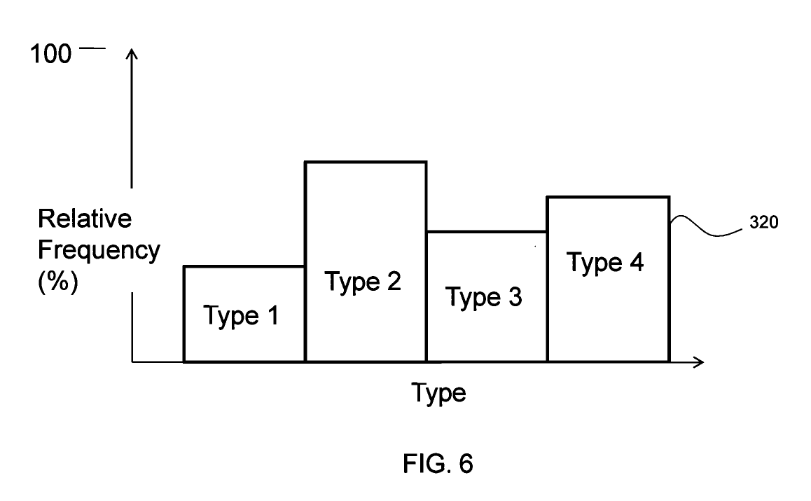

Referring to FIG. 6, a desired distribution of image types is illustrated in which the relative frequency of each image type 320 is shown by the height of the corresponding column. The relative frequency ranges from 0% (not desired in any selected digital image) to 100% (desired in all selected digital images).

In another preferred embodiment of the present invention, a desired distribution can include more than, but not fewer than, the specified relative frequency of image types. This simplifies the task of selecting images when a digital image has more than one image type. For example, if a desired distribution requires a certain relative frequency of close-up images and a different relative frequency of portrait images, a close-up image that is also a portrait image can be selected, even if the relative frequency of portrait images in a desired distribution is then exceeded. In various preferred embodiments of the present invention, variation in the relative frequency of images of specified image types can be controlled, for example within a range such as a minimum 60% to maximum 80% range or 60% to 100%. Rules can be associated with the image selection (step 215) to control the image selection process in accordance with the desired distribution, for example specifying a desired degree of flexibility in selecting images that have multiple image types.

According to further preferred embodiments of the present invention, digital images are automatically selected from the plurality of digital images to match the desired distribution.

According to yet another preferred embodiment of the present invention, different desired distributions of digital images in a common plurality of digital images can be specified for multiple photo-products. For example, if multiple people take a scenic vacation together, a commemorative photo-album for each person can be created that emphasizes images of different image types preferred by that person specified by different digital image desired distributions. Thus, the same collection of digital images can be used to produce multiple photo-products having different image-type desired distributions, for example for different intended recipients of the photo-products. In another example, a person might enjoy a beach vacation and wish to specify a photo-product such as a photo-album for each of his or her parents, siblings, friends, and others. In each photo-album, a relatively greater number of pictures including the recipient can be provided. Thus, a different selection of digital images is specified by a different desired distribution of digital images.

In one preferred embodiment of the present invention, the various methods of the present invention are performed automatically using, for example, computer systems such as those described further below. Means for receiving images, photo-product choices, and desired distributions, e.g. using communication circuits and networks, are known, as are means for manually selecting digital images and specifying photo-products, e.g. by using software executing on a processor or interacting with an on-line computer server.

Returning to FIG. 1, a method of a preferred embodiment of the present invention can further include the steps of removing bad images in step 201, for example by analyzing the images to discover duplicate images or dud images. A duplicate image can be an exact copy of an image in the plurality of images, a copy of the image at a different resolution, or a very similar image. A dud image can be a very poor image, for example an image in which the flash failed to fire or was ineffective, an image in which the camera lens of an image-capturing camera was obscured by a finger or other object, an out-of-focus image, or an image taken in error.

A user can provide a photo-product choice that is received in step 205. The user can also provide a desired distribution of image types that is received in step 210. In a further preferred embodiment of the present invention, the image quality of the digital images in the plurality of digital images is determined in step 214, for example by analyzing the composition, color, and exposure of the digital images, and ranked. A similarity metric can also be employed describing the similarity of each digital image in the plurality of digital images to every other digital image in the plurality of digital images. Quality and similarity measures are known in the art together with software executing on a processor to determine such measures on a collection of digital images and can be employed to assist in the optional duplication and dud detection steps (step 201) and to aid in the image-selection process (step 215). For example, if a desired distribution requires a close-up, portrait image of a person and several such digital images are present in the plurality of digital images, the digital image having the best image quality and the least similarity to other digital images can be chosen. The selected images then specify the photo-product (step 220). The similarity and quality values can be associated with a digital image as image metadata stored with the digital image in a common electronic file or associated with the digital image in a separate electronic file. Once the number and types of digital images are selected, the specified photo-product can be laid out and completed, as is known by practitioners in the art, and then caused to be manufactured (step 225) and delivered to a recipient.

Optional steps according to various preferred embodiments of the present invention are illustrated in the figures with dashed rectangles in the flow-diagram figures. Moreover, in many cases it is not necessary that the steps shown in the flow diagrams of preferred embodiments of the present invention be performed in the order illustrated. For example, the order in which the photo-product choice, the desired distribution, and the digital images are received can be immaterial.

In further preferred embodiments of the present invention, the image types can be automatically determined in step 202, for example by analyzing the digital images using software executing mathematical algorithms on an electronic processor. Such mathematics, algorithms, software, and processors are known in the art. Alternatively, the image types can be determined manually, for example by an owner of the digital images interacting with the digital images through a graphic interface on a digital computer and providing metadata to the processing system which is stored therein. The metadata can be stored in a metadata database associated with the digital image collection or with the digital image itself, for example in a file header.

Using computer methods described in the article “Rapid object detection using a boosted cascade of simple features,” by P. Viola and M. Jones, in Computer Vision and Pattern Recognition, 2001, Proceedings of the 2001 IEEE Computer Society Conference, 2001, pp. I-511-I-518 vol. 1; or in “Feature-centric evaluation for efficient cascaded object detection,” by H. Schneiderman, in Computer Vision and Pattern Recognition, 2004; Proceedings of the 2004 IEEE Computer Society Conference, 2004, pp. II-29-II-36, Vol. 2., the size and location of each face can be found within each digital image and is useful in determining close-up types of images and images containing people. These two documents are incorporated by reference herein in their entirety. Viola utilizes a training set of positive face and negative non-face images. The face classification can work using a specified window size. This window is slid across and down all pixels in the image in order to detect faces. The window is enlarged so as to detect larger faces in the image. The process repeats until all faces of all sizes are found in the image. Not only will this process find all faces in the image, it will return the location and size of each face.

Active shape models as described in “Active shape models—their training and application,” by Cootes, T. F. Cootes, C. J. Taylor, D. H. Cooper, and J. Graham, Computer Vision and Image Understanding, vol. 61, pp. 38-59, 1995, can be used to localize all facial features such as eyes, nose, lips, face outline, and eyebrows. These documents are incorporated by reference herein in their entirety. Using the features that are thus found, it is possible to determine if eyes/mouth are open, or if the expression is happy, sad, scared, serious, neutral, or if the person has a pleasing smile. Determining pose uses similar extracted features, as described in “Facial Pose Estimation Using a Symmetrical Feature Model”, by R. W. Ptucha, A. Savakis, Proceedings of ICME—Workshop on Media Information Analysis for Personal and Social Applications, 2009, which develops a geometric model that adheres to anthropometric constraints. This document is incorporated by reference herein in its entirety. With pose and expression information stored for each face, preferred embodiments of the present invention can be programmed to classify digital images according to these various detected types (happy, sad, scared, serious, neutral).

A main subject detection algorithm, such as the one described in U.S. Pat. No. 6,282,317, which is incorporated herein by reference in its entirety, involves segmenting a digital image into a few regions of homogeneous properties such as color and texture. Region segments can be grouped into larger regions based on such similarity measures. Regions are algorithmically evaluated for their saliency using two independent yet complementary types of saliency features—structural saliency features and semantic saliency features. The structural saliency features are determined by measureable characteristics such as location, size, shape and symmetry of each region in an image. The semantic saliency features are based upon previous knowledge of known objects/regions in an image which are likely to be part of foreground (for example, statues, buildings, people) or background (for example, sky, grass), using color, brightness, and texture measurements. For example, identifying key features such as flesh, face, sky, grass, and other green vegetation by algorithmic processing are well characterized in the literature.

In one preferred embodiment, once the image types are determined for each of the digital images in the plurality of digital images, the relative frequency of digital images of each image type can optionally be determined in step 203. For example, if a collection of 60 digital images is provided and 30 are determined by the processing system to be scenic, then the relative frequency data stored in association with the collection is a value representing 50%. This information can be useful when selecting the digital images from the collection (step 215) to satisfy a specified photo-product (step 220).

The relative frequency of image types in an image collection can also be optionally used by selecting the photo-product (step 206) to have a desired distribution dependent on the relative frequency of image types in an image collection, since a given photo-product (e.g. a user-selected photo-product) can require a certain number of image types of digital images in a collection that may or may not be available in the image collection. The desired distribution can have an equivalent image-type distribution to the image-type distribution of the image collection, for example without repeating any digital images. Therefore, a photo-product can be selected, suggested to a user, or modified depending on the relative frequency or number of digital images of each image type in a digital image collection.

Similarly, the relative frequency of image types can also be optionally be used to select the image type distribution (step 211), since a distribution can require a certain relative frequency or number of image types of digital images in a collection. If, for example, a photo-product requires a certain number of images and a first image-type distribution cannot be satisfied with a given image collection, an alternative second image-type distribution can be selected. A variety of ways to specify an alternative second image-type distribution can be employed. For example, a second image-type distribution including the same image types but requiring fewer of each image type can be selected. Alternatively, a second image-type distribution including image types related to the image types required by the first distribution (e.g. a group image with a different number of people) can be selected. Therefore, a distribution can be selected depending on the relative frequency or number of digital images of each image type in a collection.

A photo-product having a distribution (and possibly a theme and intended audience) can thus be suggested to a user, depending on the relative frequency or number of image types in a digital image collection. Therefore, according to a preferred method of the present invention, a different desired distribution is specified, received, or provided for each of a variety of different audiences or recipients.

A type of digital image can be an image with an identified person. For example, an image type can be a digital image including a specific person, for example the digital image photographer, a colleague, a friend, or a relative of the digital image photographer as identified by image metadata. Thus a distribution of digital images in a collection can include a distribution of specified individuals and a variety of the digital images that include a desired distribution of persons can be selected. For example, a variety of the digital images can include a desired distribution of close-up, individual, or group images including a desired person.

Thus, a preferred embodiment of the present invention includes analyzing the digital images to determine the identity of persons found in the digital images, forming one or more desired distributions of digital images depending on each of the person identities, selecting a variety of the digital images each satisfying the desired distribution, and specifying a photo-product that includes each of the selected varieties of digital images.

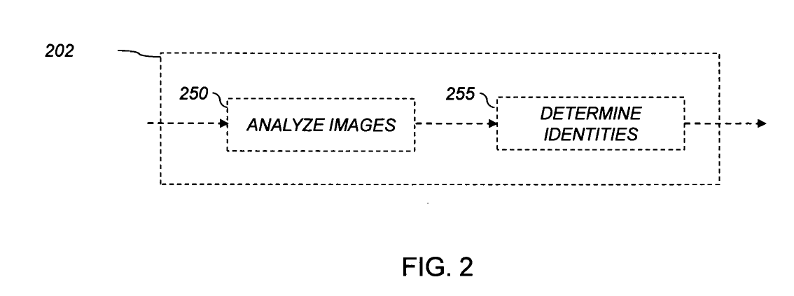

Referring to FIG. 2, automatically determining image types in step 202 can include analyzing a digital image (step 250) to determine the identity of any persons in the digital image (step 255). Algorithms and software executing on processors for locating and identifying individuals in a digital image are known. Thus, a chosen photo-product can be specified that includes a desired distribution of images of specific people. For example, at a family reunion, it might be desired to specify a distribution of image types that includes a digital image of at least one of every member of the family. If 100 digital images are taken, then the distribution can include 1% of the image types for each member. If 20 family members are at the reunion, this distribution then requires that 20% of the pictures are allocated to digital images of members (excluding group images). Depending on rules that are associated with the image selection process (step 215 of FIG. 1) a balance can be maintained between numbers of digital images of each family member in the specified photo-product. Likewise, the number of individual or group images can be controlled to provide a desired outcome. If the desired distribution cannot be achieved with the provided plurality of digital images, the determination of the relative frequency of image types (step 203) can demonstrate the problem and an alternative photo-product (step 206) or distribution (step 211) selected or suggested. Since automated face finding and recognition software is available in the art, it is thus possible, in a preferred embodiment of the present invention, to simply require that a photo-product include at least one image of each individual in a digital image collection, thus indirectly specifying a distribution. Such an indirect distribution specification is included as a specified distribution in a preferred embodiment of the present invention.

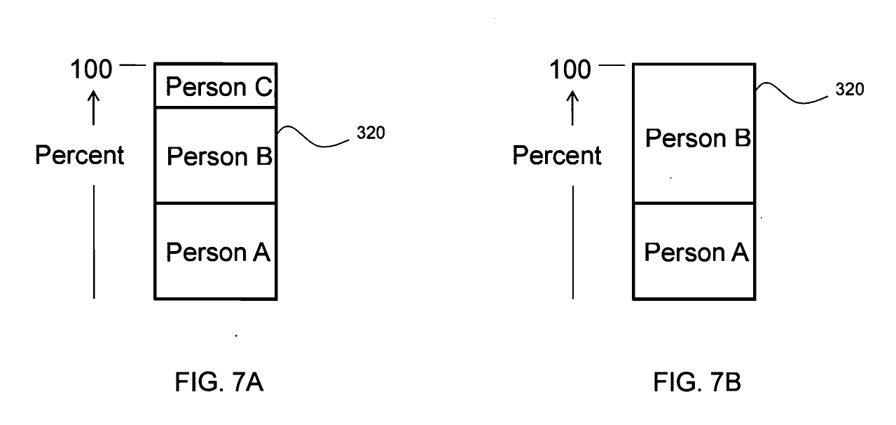

Referring to FIGS. 7A and 7B, desired relative frequencies of individual image types for two different distributions are illustrated. In FIG. 7A, persons A and B are desired to be equally represented in the distribution of selected digital images, while person C is desired to be represented less often. In FIG. 7B, person B is desired to be represented in the selected digital images more frequently than person A, and person C is not represented at all.

Since images frequently include more than one individual, it can be desirable, as discussed above to include a selection rule that makes the desired distribution a minimum, or that controls the number of group images versus individual images. Thus, a person can be included in a minimum number of selected images, selected individual images, or selected group images, for example corresponding to a distribution similar to that illustrated in FIG. 6.

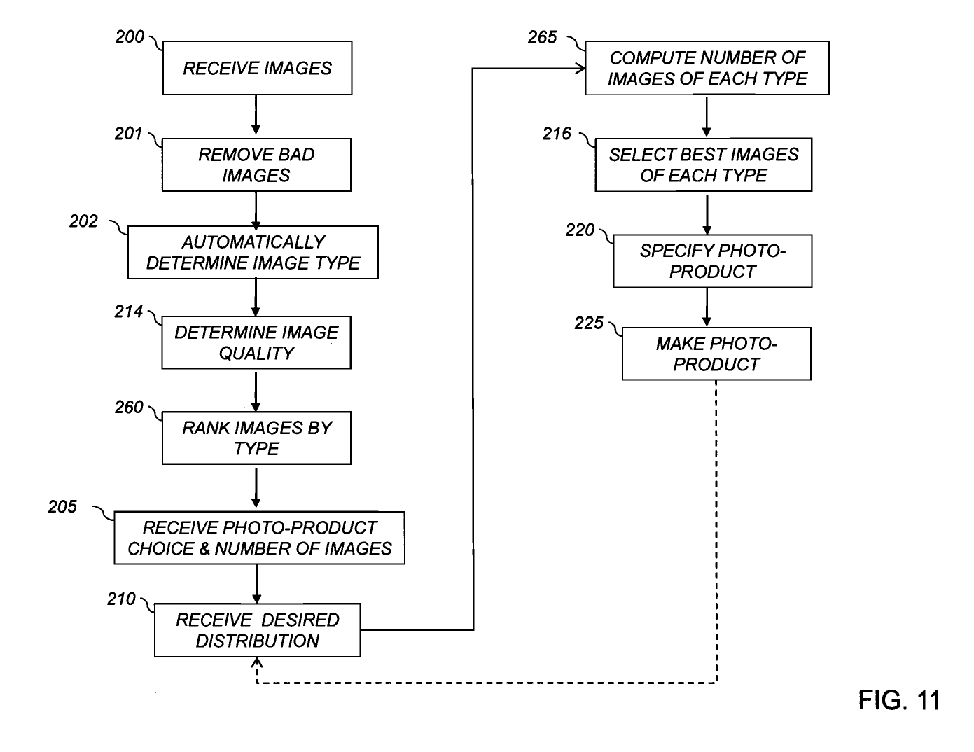

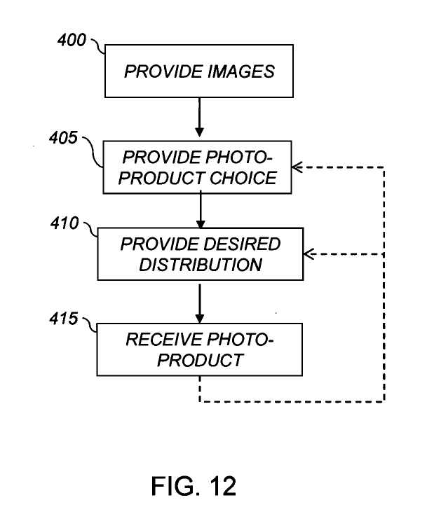

Referring to FIGS. 11 (for a photo-product service) and 12 (for a user), in one preferred embodiment of the present invention a user acquires a collection of digital images of a variety of image types and provides them (step 400) to a photo-product service that receives the plurality of digital images (step 200). Bad images (e.g. duplicates and duds) are removed in step 201 and the types of images are automatically determined in step 202. The image quality is determined in step 214 and the digital images are ranked in image quality and optionally in similarity by image type in step 260 (e.g. digital images of a common image type are ranked in terms of relative image quality or similarity). The user provides a photo-product choice (that can include a number of images desired in the photo-product) in step 405; the choice is received by the photo-product service in step 205. Likewise, the user provides a desired distribution of image types in step 410; the distribution is received by the photo-product service in step 210. The number of images of each image type in the plurality of images is computed in step 265 and the best images of each image type are selected in step 216 corresponding to the received distribution of image types. The photo-product is then specified in step 220, caused to be manufactured in step 225 and shipped or distributed to the user who receives the manufactured photo-product in step 415.

In further preferred embodiments of the present invention, the user provides additional image-product choices or desired distributions for the same image collection and the image-product service repeatedly receives the additional choices to specify and make the additional image products. Thus, in a preferred embodiment, a method of the present invention includes selecting two or more different varieties of the digital images having corresponding different desired distributions from the same plurality of digital images and specifying two or more image products of the same image-product type (e.g. two or more photo-albums), each photo-product including a different one of the different varieties of the digital images. Alternatively, different image-product types (e.g. a photo-album and a photo-collage) can be specified and each image product can include a different one of the different varieties of the digital images.

Users can specify image-type distributions using a computer, for example a desktop computer known in the prior art. A processor can be used to provide a user interface, the user interface including controls for setting the relative frequencies of digital images of each image type. Likewise, a preferred method of the present invention can include using a processor to receive a distribution of image types that includes a range of relative frequencies of image types.

In any of these embodiments, the digital image can be a still image, a graphical element, or a video image sequence, and can include an audio element. The digital images can be multi-media elements.

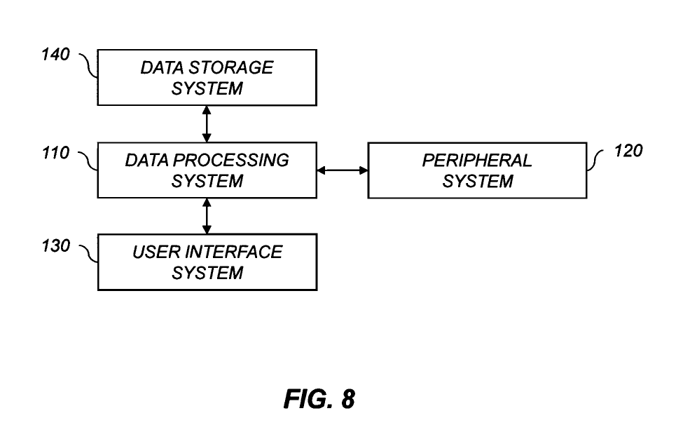

Preferred embodiments of the present invention can be implemented using a variety of computers and computer systems illustrated in FIGS. 8, 9 and 10 and discussed further below. In one preferred embodiment, for example, a desktop or laptop computer executing a software application can provide a multi-media display apparatus suitable for specifying distributions, providing digital image collections, or photo-product choices, or for receiving such. In a preferred embodiment, a multi-media display apparatus comprises: a display having a graphic user interface (GUI) including a user-interactive GUI pointing device; a plurality of multi-media elements displayed on the GUI, and user interface devices for providing means to a user to enter information into the system. A desktop computer, for example, can provide such an apparatus.

In another preferred embodiment, a computer server can provide web pages that are served over a network to a remote client computer. The web pages can allow a user of the remote client computer to provide digital images, photo-product, and distribution choices. Applications provided by the web server to a remote client can enable presentation of selected multi-media elements, either as stand-alone software tools or provided through html, Java, or other known-internet interactive tools. In this preferred embodiment, a multi-media display system comprises: a server computer providing graphical user interface display elements and functions to a remote client computer connected to the server computer through a computer network such as the internet, the remote client computer including a display having a graphic user interface (GUI) including a user-interactive GUI pointing device; and a plurality of multi-media elements stored on the server computer, communicated to the remote client computer, and displayed on the GUI.

Computers and computer systems are stored program machines that execute software programs to implement desired functions. According to a preferred embodiment of the present invention, a software program executing on a computer with a display and graphic user interface (GUI) including a user-interactive GUI pointing device includes software for displaying a plurality of multi-media elements having images on the GUI and for performing the steps of the various methods described above.

FIG. 8 is a high-level diagram showing the components of a system useful for various preferred embodiments of the present invention. The system includes a data processing system 110, a peripheral system 120, a user interface system 130, and a data storage system 140. The peripheral system 120, the user interface system 130 and the data storage system 140 are communicatively connected to the data processing system 110. The system can be interconnected to other data processing or storage system through a network, for example the internet.

The data processing system 110 includes one or more data processing devices that implement the processes of the various preferred embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, a digital picture frame, cellular phone, a smart phone or any other device for processing data, managing data, communicating data, or handling data, whether implemented with electrical, magnetic, optical, biological components, or otherwise.

The data storage system 140 includes one or more processor-accessible memories configured to store information, including the information needed to execute the processes of the various preferred embodiments of the present invention, including the example processes described herein. The data storage system 140 can be a distributed processor-accessible memory system including multiple processor-accessible memories communicatively connected to the data processing system 110 via a plurality of computers or devices. On the other hand, the data storage system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, caches, floppy disks, hard disks, Compact Discs, DVDs, flash memories, ROMs, and RAMs.

The phrase “communicatively connected” is intended to include any type of connection, whether wired or wireless, between devices, data processors, or programs in which data is communicated. The phrase “communicatively connected” is intended to include a connection between devices or programs within a single data processor, a connection between devices or programs located in different data processors, and a connection between devices not located in data processors at all. In this regard, although the data storage system 140 is shown separately from the data processing system 110, one skilled in the art will appreciate that the data storage system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110.

The peripheral system 120 can include one or more devices configured to provide digital content records to the data processing system 110. For example, the peripheral system 120 can include digital still cameras, digital video cameras, cellular phones, smart phones, or other data processors. The data processing system 110, upon receipt of digital content records from a device in the peripheral system 120, can store such digital content records in the data storage system 140.

The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130.

The user interface system 130 also can include a display device, a processor-accessible memory, or any device or combination of devices to which data is output by the data processing system 110. In this regard, if the user interface system 130 includes a processor-accessible memory, such memory can be part of the data storage system 140 even though the user interface system 130 and the data storage system 140 are shown separately in FIG. 8.

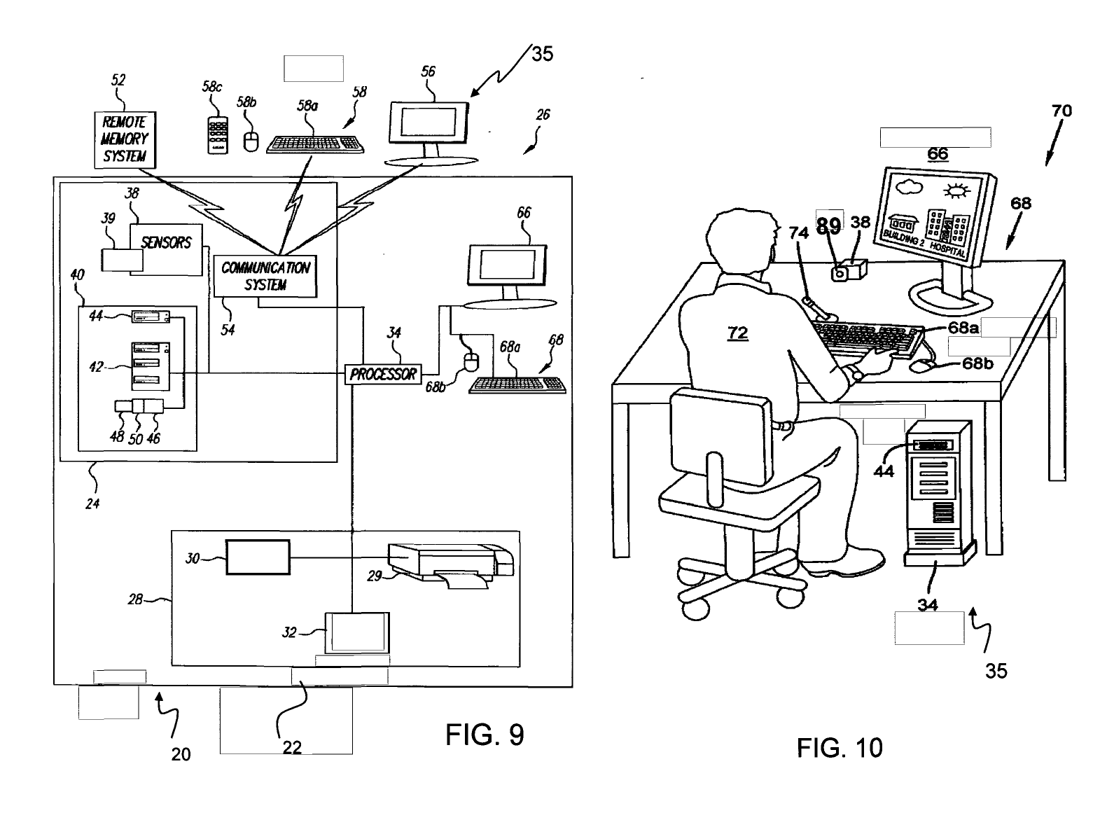

Referring to FIGS. 9 and 10, computers, computer servers, and a communication system are illustrated together with various elements and components that are useful in accordance with various preferred embodiments of the present invention. FIG. 9 illustrates a preferred embodiment of an electronic system 20 that can be used in generating an image product. In the preferred embodiment of FIG. 9, electronic system 20 comprises a housing 22 and a source of content data files 24, a user input system 26 and an output system 28 connected to a processor 34. The source of content data files 24, user-input system 26 or output system 28 and processor 34 can be located within housing 22 as illustrated. In other preferred embodiments, circuits and systems of the source of content data files 24, user input system 26 or output system 28 can be located in whole or in part outside of housing 22.

The source of content data files 24 can include any form of electronic or other circuit or system that can supply digital data to processor 34 from which processor 34 can derive images for use in forming an image-enhanced item. In this regard, the content data files can comprise, for example and without limitation, still images, image sequences, video graphics, and computer-generated images. Source of content data files 24 can optionally capture images to create content data for use in content data files by use of capture devices located at, or connected to, electronic system 20 and/or can obtain content data files that have been prepared by or using other devices. In the preferred embodiment of FIG. 9, source of content data files 24 includes sensors 38, a memory 40 and a communication system 54.

Sensors 38 are optional and can include light sensors, biometric sensors and other sensors known in the art that can be used to detect conditions in the environment of system 20 and to convert this information into a form that can be used by processor 34 of system 20. Sensors 38 can also include one or more video sensors 39 that are adapted to capture images. Sensors 38 can also include biometric or other sensors for measuring involuntary physical and mental reactions such sensors including, but not limited to, voice inflection, body movement, eye movement, pupil dilation, body temperature, and p4000 wave sensors.

Memory 40 can include conventional memory devices including solid-state, magnetic, optical or other data-storage devices. Memory 40 can be fixed within system 20 or it can be removable. In the preferred embodiment of FIG. 9, system 20 is shown having a hard drive 42, a disk drive 44 for a removable disk such as an optical, magnetic or other disk memory (not shown) and a memory card slot 46 that holds a removable memory 48 such as a removable memory card and has a removable memory interface 50 for communicating with removable memory 48. Data including, but not limited to, control programs, digital images and metadata can also be stored in a remote memory system 52 such as a personal computer, computer network or other digital system. Remote memory system 52 can also include solid-state, magnetic, optical or other data-storage devices.

In the preferred embodiment shown in FIG. 9, system 20 has a communication system 54 that in this preferred embodiment can be used to communicate with an optional remote memory system 52, an optional remote display 56, and/or optional remote input 58. The optional remote memory system 52, optional remote display 56, optional remote input 58A can all be part of a remote system 21 having an input station 58 having remote input controls 58 (also referred to herein as “remote input 58”), can include a remote display 56, and that can communicate with communication system 54 wirelessly as illustrated or can communicate in a wired fashion. In an alternative embodiment, a local input station including either or both of a local display 66 and local input controls 68 (also referred to herein as “local user input 68”) can be connected to communication system 54 using a wired or wireless connection.

Communication system 54 can comprise for example, one or more optical, radio frequency or other transducer circuits or other systems that convert image and other data into a form that can be conveyed to a remote device such as remote memory system 52 or remote display 56 using an optical signal, radio frequency signal or other form of signal. Communication system 54 can also be used to receive a digital image and other data from a host or server computer or network (not shown), a remote memory system 52 or a remote input 58. Communication system 54 provides processor 34 with information and instructions from signals received thereby. Typically, communication system 54 will be adapted to communicate with the remote memory system 52 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system. In one useful preferred embodiment, the system 20 can provide web access services to remotely connected computer systems (e.g. remote systems 35) that access the system 20 through a web browser. Alternatively, remote system 35 can provide web services to system 20 depending on the configurations of the systems.

User input system 26 provides a way for a user of system 20 to provide instructions to processor 34. This allows such a user to make a designation of content data files to be used in generating an image-enhanced output product and to select an output form for the output product. User input system 26 can also be used for a variety of other purposes including, but not limited to, allowing a user to arrange, organize and edit content data files to be incorporated into the image-enhanced output product, to provide information about the user or audience, to provide annotation data such as voice and text data, to identify characters in the content data files, and to perform such other interactions with system 20 as will be described later.

In this regard user input system 26 can comprise any form of transducer or other device capable of receiving an input from a user and converting this input into a form that can be used by processor 34. For example, user input system 26 can comprise a touch screen input, a touch pad input, a 4-way switch, a 6-way switch, an 8-way switch, a stylus system, a trackball system, a joystick system, a voice recognition system, a gesture recognition system a keyboard, a remote control or other such systems. In the preferred embodiment shown in FIG. 9, user input system 26 includes an optional remote input 58 including a remote keyboard 58a, a remote mouse 58b, and a remote control 58c and a local input 68 including a local keyboard 68a and a local mouse 68b.

Remote input 58 can take a variety of forms, including, but not limited to, the remote keyboard 58a, remote mouse 58b or remote control handheld device 58c illustrated in FIG. 9. Similarly, local input 68 can take a variety of forms. In the preferred embodiment of FIG. 9, local display 66 and local user input 68 are shown directly connected to processor 34.

As is illustrated in FIG. 10, local user input 68 can take the form of a home computer, an editing studio, or kiosk 70 (hereafter also referred to as an “editing area 70”) that can also be a remote system 35 or system 20. In this illustration, a user 72 is seated before a console comprising local keyboard 68a and mouse 68b and a local display 66 which is capable, for example, of displaying multimedia content. As is also illustrated in FIG. 10, editing area 70 can also have sensors 38 including, but not limited to, video sensors 39, audio sensors 74 and other sensors such as multispectral sensors that can monitor user 72 during a production session.

Output system 28 is used for rendering images, text or other graphical representations in a manner that allows image-product designs to be combines with user items and converted into an image product. In this regard, output system 28 can comprise any conventional structure or system that is known for printing or recording images, including, but not limited to, printer 29. Printer 29 can record images on a tangible surface 30 using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology, drop-on-demand inkjet technology and continuous inkjet technology. For the purpose of the following discussions, printer 29 will be described as being of a type that generates color images. However, it will be appreciated that this is not necessary and that the claimed methods and apparatuses herein can be practiced with a printer 29 that prints monotone images such as black and white, grayscale, or sepia toned images. As will be readily understood by those skilled in the art, a system 35, 20 with which a user interacts to define a user-personalized image product can be separated from a remote system (e.g. 35, 20) connected to a printer, so that the specification of the image product is remote from its production.

In certain preferred embodiments, the source of content data files 24, user input system 26 and output system 28 can share components.

Processor 34 operates system 20 based upon signals from user input system 26, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components. The system 20 of FIGS. 9 and 10 can be employed to make and display an image product according to a preferred embodiment of the present invention.

The invention has been described in detail with particular reference to certain preferred embodiments thereof, but it will be understood that variations and modifications can be effected within the spirit and scope of the invention.

### PARTS LIST

20 system
22 housing
24 source of content data files
26 user input system
27 graphic user interface
28 output system
29 printer
30 tangible surface
34 processor
35 remote system
38 sensors
39 video sensors
40 memory
42 hard drive
44 disk drive
46 memory card slot
48 removable memory
50 memory interface
52 remote memory system
54 communication system
56 remote display
58 remote input
58a remote keyboard
58b remote mouse
58c remote control
66 local display
68 local input
68a local keyboard
68b local mouse
70 home computer, editing studio, or kiosk
72 user
74 audio sensors
110 data processing system
120 peripheral system
130 user interface system
140 data storage system
200 receive images step
201 remove bad images step
202 automatically determine image type step
203 determine relative frequency of image types step
205 receive photo-product choice step
206 select photo-product choice step
210 receive desired distribution step
211 select distribution step
214 determine image quality step
215 select image step
216 select best images of each type step
220 specify photo-product step
225 make photo-product step
250 analyze images step
255 determine identities step
260 rank images by type
265 compute number of image of each type step
300 type count
310 percent type distribution
320 percent person distribution
400 provide images step
405 provide photo-product choice step
410 provide desired distribution step
415 receive photo-product step

1. An apparatus for making an image-product, comprising:
electronic memory for storing a plurality of digital images, wherein each of said digital images has associated therewith type data stored in the electronic memory indicating one of a plurality of image types for classifying its associated digital image, and wherein the plurality of electronically stored digital images includes digital images of a plurality of different image types; and
a processor coupled to the electronic memory for electronically selecting multiple ones of the plurality of stored digital images using the stored type data for forming a first image distribution, the first image distribution matching a first predefined distribution of image types.

2. The apparatus of claim 1, further comprising means for incorporating the selected multiple ones of the plurality of stored digital images into an image product.

3. The apparatus of claim 2, further comprising means for incorporating the selected multiple ones of the plurality of stored digital images into another image product.

4. The apparatus of claim 2, further comprising means for incorporating the selected multiple ones of the plurality of stored digital images into a plurality of different image products of different image-product types.

5. The apparatus of claim 1, further comprising means for determining a relative frequency of each said image type associated with the plurality of electronically stored digital images.

6. The apparatus of claim 1, further comprising means for determining an image distribution of the plurality of electronically stored digital images and means for defining the first predefined distribution as equivalent to said image distribution of the plurality of electronically stored digital images.

7. The apparatus of claim 1, further comprising means for defining a second predefined distribution which is a function of the first predefined distribution for forming a second image distribution when the first predefined distribution cannot be satisfied.

8. The apparatus of claim 1, wherein said plurality of different image types includes two or more of the following image types: portrait orientation, landscape orientation, scenic image, image that includes a person, close-up image of a person, group image that includes multiple people, scenic image that includes a person, day-time image, night-time image, image-usage, image including one or more animals, black-and-white image, color image, identified person, identified gender, flash-exposed image, similarity, and aesthetic value.

9. The apparatus of claim 1, wherein the first predefined distribution comprises a specified distribution of identified persons.

10. The apparatus of claim 1, wherein said plurality of different image types includes an identified person type.

11. The apparatus of claim 1, wherein the predefined distribution comprises a specified distribution of close-up, individual, or group images including an identified person.

12. The apparatus of claim 1, further comprising means for repeating the step of electronically selecting multiple ones of the plurality of stored digital images and means for generating a different set of selected multiple ones of the digital images with each repetition.

13. The apparatus of claim 1, further comprising means for incorporating said different sets of selected multiple ones of the digital images each into one type of image-product.

14. The apparatus of claim 1, further comprising means for removing duplicate or dud digital images from the plurality of the electronically stored digital images.

15. The apparatus of claim 1, further comprising means for ranking a quality or similarity of the electronically stored digital images and means for using the quality or similarity ranking for preferentially performing the step of electronically selecting.

16. The apparatus of claim 2, wherein the image-product is selected from the group consisting of a photo-book, a photo-card, and a photo-collage.

17. The apparatus of claim 1, further including:
means for analyzing the plurality of electronically stored digital images to identify persons captured in the digital images;
means for generating and storing a plurality of predefined distributions based on the persons identified;
means for electronically selecting different groups of digital images from the plurality of stored digital images, each group matching one of the plurality of predefined distributions; and
means for incorporating the different groups of digital images each into an image-product.

18. The apparatus of claim 1, wherein the processor for electronically selecting includes means for electronically selecting multiple ones of the plurality of stored digital images for forming groups of the selected digital images, each of the groups for matching one of a plurality of different predefined distributions of image types.

19. The apparatus of claim 1, further comprising a user interface, the user interface for receiving user selections for defining the first predefined distribution of image types.

20. The apparatus of claim 14, wherein the first predefined distribution includes relative percentages of the image types.

21. A system for making an image product, comprising:
a processor;
a digital image storage device connected to the processor;
means for receiving a plurality of digital images, each of the digital images having type data associated therewith for indicating a type of the digital images, the plurality of digital images including digital images of at least two different types;
means for storing the digital images and the type data in the digital image storage device;
means for selecting a variety of the digital images that satisfies a specified distribution of the digital image types; and
means for selecting a photo-product for inclusion of the selected variety of the digital images.
